(19) United States
(12) Patent Application Publication
(10) Pub. No.: US 2026/0247445 A1
(43) Pub. Date: Aug. 20, 2026

(54) RA-RNTI CALCULATION FOR MULTI-PRACH TRANSMISSIONS

(71) Applicant: Panasonic Intellectual Property Corporation of America, Torrance, CA (US)

(72) Inventors: Xuan Tuong TRAN, Singapore (SG); Hidetoshi SUZUKI, Kanagawa (JP); Yang KANG, Singapore (SG); Yoshihiko OGAWA, Kanagawa (JP)

(73) Assignee: Panasonic Intellectual Property Corporation of America, Torrance, CA (US)

(21) Appl. No.: 19/152,823

(22) PCT Filed: Aug. 11, 2023
(86) PCT No.: PCT/SG2023/050552

§ 371 Date: Jul. 31, 2025

(30) Foreign Application Priority Data
Feb. 3, 2023 (SG) 10202300280P

(51) Int. Cl. H04W 74/0833; H04L 5/00; H04W 72/232; H04W 74/00

(52) U.S. Cl. CPC H04W 74/0833; H04L 5/0007; H04W 72/232; H04W 74/004; H04W 74/006

(57) ABSTRACT

The present disclosure provides communication apparatuses and communication methods for random access radio network temporary identifier (RA-RNTI) calculation for multi-physical Random Access Channel (multi-PRACH) transmissions. The communication apparatuses include a communication apparatus comprising: a transmitter, which in operation, transmits a preamble in at least one of a plurality of Random Access Channel occasions (ROs) of a first RO group; and a receiver, which in operation, receives downlink control information (DCI) with cyclic redundancy check (CRC) scrambled by one or more random access radio network temporary identifier (RA-RNTI) candidates, the one or more RA-RNTI candidates being determined based on at least one of the plurality of ROs.

### TECHNICAL FIELD

The present disclosure relates to communication apparatuses and communication methods for random access radio network temporary identifier (RA-RNTI) calculation for multi-physical Random Access Channel (multi-PRACH) transmissions.

### BACKGROUND

Random access radio network temporary identifier (RA-RNTI) is used for determining random-access response (RAR) data (e.g., Msg2) during random access procedure [Table 7.1-2: RNTI usage in TS 38.321]. In the current technical specifications, a user equipment (UE) sends a preamble (e.g., Msg1) over a physical Random Access Channel (PRACH) channel to a base station (gNB) to get uplink (UL) synchronization in a single-PRACH transmission scenario. The gNB later sends a RAR (Msg2) to the UE as a response to the preamble transmission that was sent by the UE. The UE then attempts to detect a downlink control information (DCI) with a cyclic redundancy check (CRC) scrambled by a calculated RA-RNTI within a RAR window.

Uplink (UL) channel performance could be challenging in most of scenarios in real deployment, while there are emerging vertical use cases that require UL heavy traffic, e.g., video uploading or camera surveillance. It was studied to identify that PRACH is one of bottleneck channels in term of coverage performance in 5G new radio (NR). Due to limited scope of Release (Rel.) 17 Coverage Enhancement (CovEnh), PRACH coverage has not been enhanced. Therefore, a new working item (WI) for further NR CovEnh has been approved in Rel. 18, where one of the main objectives is to improve coverage of PRACH by using multi-physical Random-Access Channel (multi-PRACH) transmissions.

However, there has still been no discussion on communication apparatuses and methods for RA-RNTI calculation for multi-PRACH transmissions.

There is thus a need for communication apparatuses and methods that provide feasible technical solutions for RA-RNTI calculation for multi-PRACH transmissions in order to to decode the corresponding RAR of multi-PRACH transmissions successfully while providing an improvement of coverage performance of PRACH. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and methods for RA-RNTI calculation for multi-PRACH transmissions.

According to a first embodiment of the present disclosure, there is provided a communication apparatus comprising: a transmitter, which in operation, transmits a preamble in at least one of a plurality of Random Access Channel occasions (ROs) of a first RO group; and a receiver, which in operation, receives downlink control information (DCI) with cyclic redundancy check (CRC) scrambled by one or more random access radio network temporary identifier (RA-RNTI) candidates, the one or more RA-RNTI candidates being determined based on at least one of the plurality of ROs.

According to a second embodiment of the present disclosure, there is provided a base station comprising: a receiver, which in operation, receives a preamble in at least one of a plurality of ROs of a first RO group from a communication apparatus; circuitry, which in operation, determines one or more RA-RNTI candidates based on the at least one of a plurality of ROs of a first RO group, and generates a DCI with CRC scrambled by the one or more RA-RNTI candidates; and a transmitter, which in operation, transmits the DCI to the communication apparatus.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 shows an exemplary 3GPP NR radio access network (NR-RAN) architecture to which exemplary embodiments of the present disclosure can be applied.

FIG. 2 depicts a schematic drawing which shows functional split between NG-RAN and 5G Core Network (5GC) to which exemplary embodiments of the present disclosure may be applied.

FIG. 3 depicts a sequence diagram for RRC (radio resource control) connection setup/reconfiguration procedures to which exemplary embodiments of the present disclosure may be applied.

FIG. 4 depicts a schematic drawing showing usage scenarios of Enhanced mobile broadband (eMBB), Massive Machine Type Communications (mMTC) and Ultra Reliable and Low Latency Communications (URLLC) to which exemplary embodiments of the present disclosure may be applied.

FIG. 5 shows a block diagram showing an exemplary 5G system architecture for vehicle to everything (V2X) communication in a non-roaming scenario to which exemplary embodiments of the present disclosure may be applied.

FIG. 6 shows an example illustration of sending a random-access response (RAR) to a user equipment (UE) in response to a preamble transmission in a single-PRACH transmission according to the current technical specifications.

FIG. 7 shows an example illustration of a RA-RNTI calculation in a random-access channel occasion (RO) UE group based on a first solution according to various embodiments of the present disclosure.

FIG. 8 shows an example illustration of a RA-RNTI candidate calculation for a RO UE group based on a first option according to various embodiments of the present disclosure.

FIG. 9 shows an example illustration of a RA-RNTI candidate calculation for a RO UE group based on a second option according to various embodiments of the present disclosure.

FIG. 10 shows an example illustration of a RA-RNTI candidate calculation for a RO UE group based on a third option according to various embodiments of the present disclosure.

FIG. 11 shows an example illustration of two RA-RNTI candidates for short and long RAR windows respectively according to various embodiments of the present disclosure.

FIG. 12 shows an example illustration of N RA-RNTI candidates for N ROS in a RO UE group according to various embodiments of the present disclosure.

FIG. 13 shows an example illustration of selecting one of a plurality of RA-RNTI candidates to determine RAR data for multi-PRACH transmission according to various embodiments of the present disclosure.

FIG. 14 shows an example illustration of selecting one of RA-RNTI candidates based on Options 4a, 4b and 4c for a UE according to various embodiments of the present disclosure.

FIG. 15 shows an example illustration of selecting RA-RNTI candidates based on a Solution 5 and an Option 5a according to various embodiments of the present disclosure.

FIG. 16 shows an example illustration of determining 2 RA-RNTI candidates for a UE according to various embodiments of the present disclosure.

FIG. 17 shows another example illustration of determining 2 RA-RNTI candidates for a UE according to various embodiments of the present disclosure.

FIG. 18 shows a flow chart for a UE according to various embodiments of the present disclosure.

FIG. 19 shows an alternative flow chart for a UE according to various embodiments of the present disclosure.

FIG. 20 shows a flow chart illustrating a communication method according to various embodiments of the present disclosure.

FIG. 21 shows a schematic block diagram of an example communication apparatus in accordance with various embodiments of the present disclosure.

FIG. 22 shows a schematic block diagram of an alternative example communication apparatus with multiple antennas in accordance with various embodiments of the present disclosure.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Some embodiments of the present disclosure will be described, by way of example only, with reference to the drawings. Like reference numerals and characters in the drawings refer to like elements or equivalents.

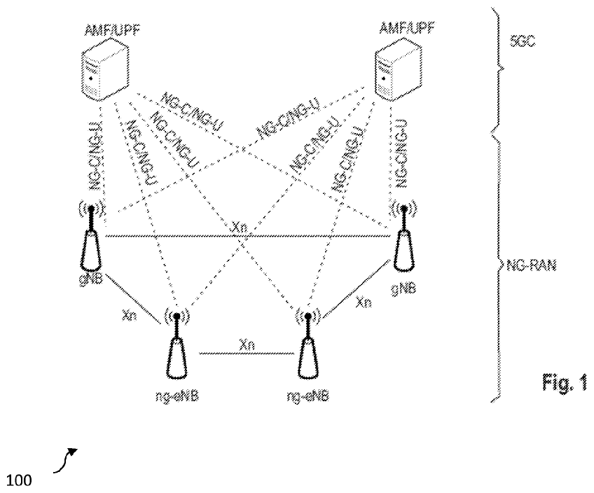

Among other things, the overall system architecture assumes an NG-RAN (Next Generation-Radio Access Network) that comprises gNBs, providing the NG-radio access user plane (SDAP/PDCP/RLC/MAC/PHY) and control plane (RRC) protocol terminations towards the user equipment (UE). The gNBs are interconnected with each other by means of the Xn interface. The gNBs are also connected by means of the Next Generation (NG) interface to the NGC (Next Generation Core), more specifically to the AMF (Access and Mobility Management Function) (e.g., a particular core entity performing the AMF) by means of the NG-C interface and to the UPF (User Plane Function) (e.g., a particular core entity performing the UPF) by means of the NG-U interface. The NG-RAN architecture 100 is illustrated in FIG. 1 (see e.g., 3GPP TS 38.300 v16.3.0, section 4).

The user plane protocol stack for NR (see e.g., 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g., sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300. Further, sidelink communications is introduced in 3GPP TS 38.300 v16.3.0. Sidelink supports UE-to-UE direct communication using the sidelink resource allocation modes, physical-layer signals/channels, and physical layer procedures (see for instance section 5.7 of TS 38.300).

For instance, the Medium-Access-Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are Physical Random Access Channel (PRACH), Physical Uplink Shared Channel (PUSCH) and Physical Uplink Control Channel (PUCCH) for uplink and Physical Downlink Shared Channel (PDSCH), Physical Downlink Control Channel (PDCCH) and Physical Broadcast Channel (PBCH) for downlink. Further, physical sidelink channels include Physical Sidelink Control Channel (PSCCH), Physical Sidelink Shared Channel (PSSCH), Physical Sidelink Feedback Channel (PSFCH) and Physical Sidelink Broadcast Channel (PSBCH).

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10⁻⁵ within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g., subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than a mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tᵤ and the subcarrier spacing Δf are directly related through the formula Δf=1/Tᵤ. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v16.3.0).

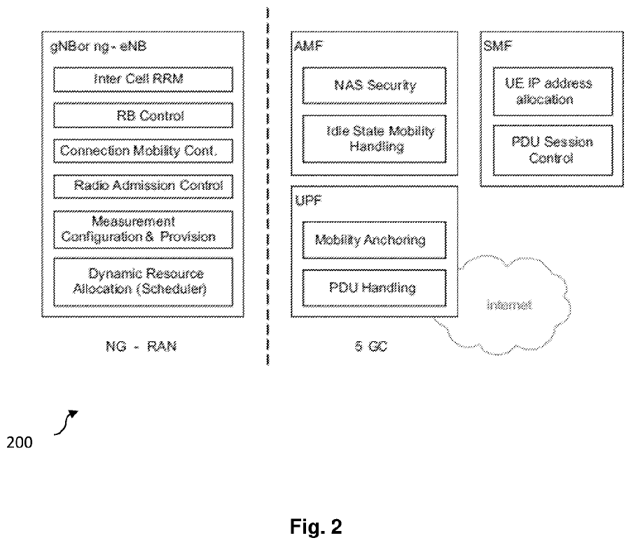

Schematic drawing 200 of FIG. 2 illustrates functional split between NG-RAN and 5GC. NG-RAN logical node is a gNB or ng-eNB. The 5GC has logical nodes Access and Mobility Management Function (AMF), User Plane Function (UPF) and Session Management Function (SMF).

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signaling termination;
NAS signaling security;
Access Stratum, AS, Security control;
Inter Core Network, CN, node signaling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

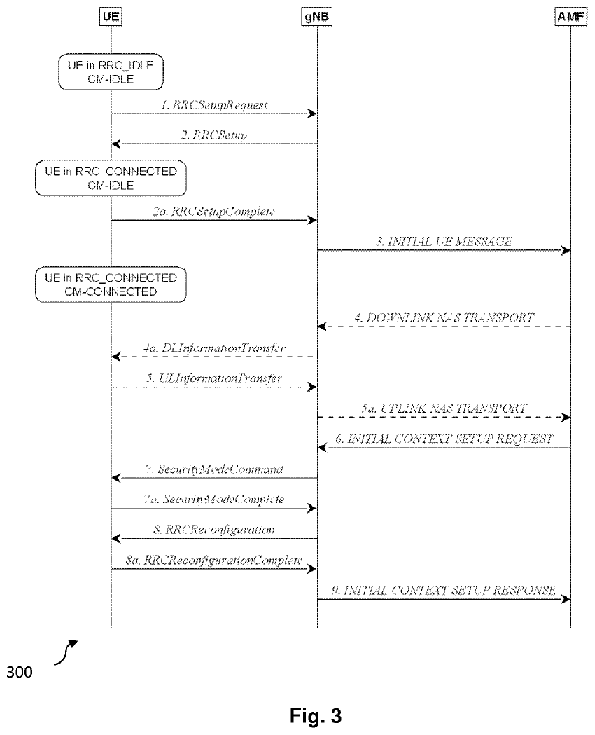

Sequence diagram 300 in FIG. 3 illustrates some interactions between a UE, gNB, and AMF (an 5GC entity) in the context of a transition of the UE from RRC_IDLE to RRC_CONNECTED for the NAS part (see TS 38.300 v16.3.0). The transition steps are as follows:
1. The UE requests to setup a new connection from RRC_IDLE.
2/2a. The gNB completes the RRC setup procedure.
NOTE: The scenario where the gNB rejects the request is described below.
3. The first NAS message from the UE, piggybacked in RRCSetupComplete, is sent to AMF.
4/4a/5/5a. Additional NAS messages may be exchanged between UE and AMF, see TS 23.502 reference [22] (3GPP TS 23.122: “Non-Access-Stratum (NAS) functions related to Mobile Station in idle mode”).
6. The AMF prepares the UE context data (including PDU session context, the Security Key, UE Radio Capability and UE Security Capabilities, etc.) and sends it to the gNB.
7/7a. The gNB activates the AS security with the UE.
8/8a. The gNB performs the reconfiguration to setup SRB2 and DRBs.
9. The gNB informs the AMF that the setup procedure is completed.

RRC is a higher layer signalling (protocol) used for UE and gNB configuration. In particular, this transition involves that the AMF prepares the UE context data (including e.g., PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

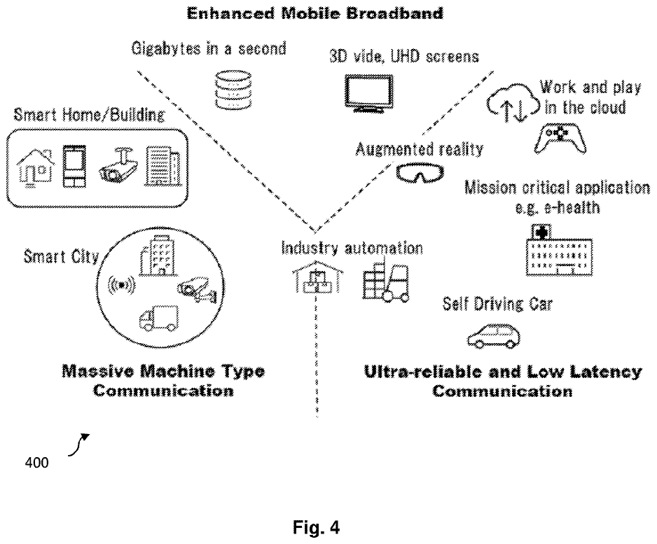

Schematic drawing 400 in FIG. 4 illustrates some use cases for 5G NR. In third generation partnership project new radio (3GPP NR), three use cases are being considered that have been envisaged to support a wide variety of services and applications by IMT-2020. The technical specification for the phase 1 of enhanced mobile-broadband (eMBB) has been concluded. In addition to further extending the eMBB support, the current and future work would involve the standardization for ultra-reliable and low-latency communications (URLLC) and massive machine-type communications (mMTC). FIG. 4 illustrates some examples of envisioned usage scenarios for IMT for 2020 and beyond (see e.g., ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, mini-slot-based scheduling with flexible mapping, grant free (configured grant) uplink, mini-slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated Channel Quality Indicator/Modulation and Coding Scheme (CQI/MCS) tables for the target BLER of 1E-5.

The use case of mMTC (massive machine-type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10⁻⁶ level), higher availability, packet sizes of up to 256 bytes, time synchronization down to the order of a few us where the value can be one or a few us depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g., as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

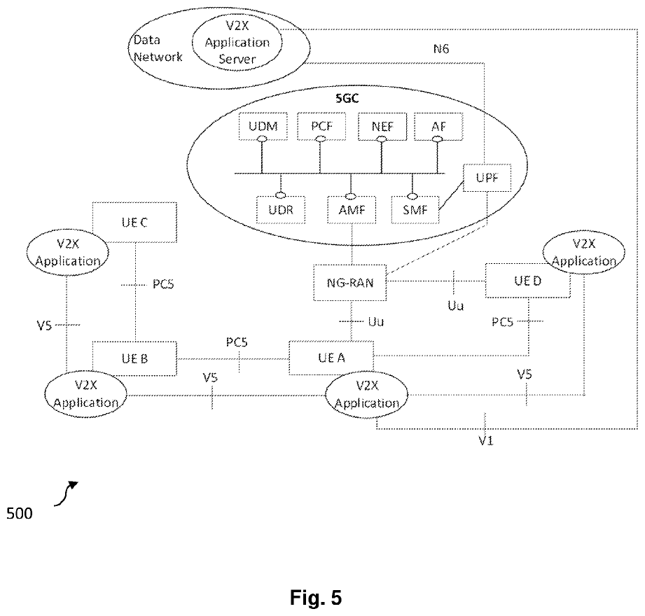

Block diagram 500 in FIG. 5 illustrates a 5G NR non-roaming reference architecture (see TS 23.287 v16.4.0, section 4.2.1.1). An Application Function (AF), e.g., an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g., QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture for V2X communication, namely, Unified Data Management (UDM), Policy Control Function (PCF), Network Exposure Function (NEF), Application Function (AF), Unified Data Repository (UDR), Access and Mobility Management Function (AMF), Session Management Function (SMF), and User Plane Function (UPF) in the 5GC, as well as with V2X Application Server (V2AS) and Data Network (DN), e.g. operator services, Internet access or third party services. All of or a part of the core network functions and the application services may be deployed and running on cloud computing environments.

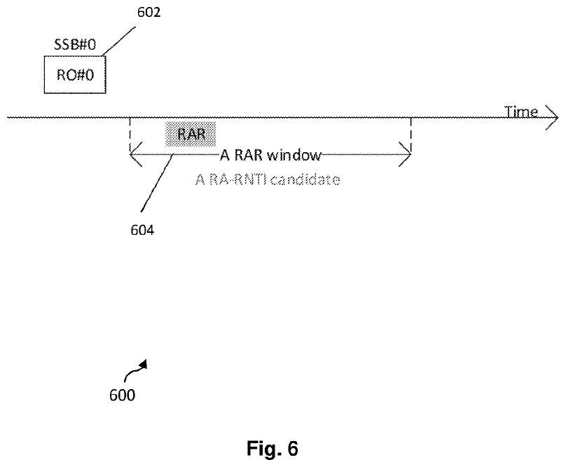

In the current technical specifications, a user equipment (UE) sends a preamble (e.g., Msg1) over a physical Random-Access Channel (PRACH) channel to a base station (gNB) to get uplink (UL) synchronization in a single-PRACH transmission scenario, for example as shown in illustration 600 of FIG. 6. Each preamble transmission (e.g., a RACH occasion (RO)) is associated with a RA-RNTI candidate which is calculated based on a RO of a single-PRACH transmission (e.g., RO 602) according to the following equation RA-RNTI=1+s_id+14×t_id+14×80×f_id+14×80×8×ul_carrier_id in TS 38.321, where s_id is the index of the first OFDM symbol of the PRACH occasion (0≤s_id<14), t_id is the index of the first slot of the PRACH occasion in a system frame (0≤t_id<80), f_id is the index of the PRACH occasion in the frequency domain (0≤f_id<8), and ul_carrier_id is the UL carrier used for PRACH preamble transmission (0 for normal uplink (NUL) carrier, and 1 for supplementary uplink (SUL) carrier). The s_id, t_id and f_id are herein referred to as a plurality of indexes of a resource (e.g., time and frequency resource) of a RO. The gNB later sends a RAR (e.g., Msg2) to the UE as a response to the preamble transmission that was sent by the UE. The UE attempts to detect a DCI with a cyclic redundancy check (CRC) that is scrambled by the above calculated RA-RNTI within a RAR window 604 (e.g., a length of the RAR window is configurable by higher-layer parameter ra-ResponseWindow). When the UE successfully decodes the DCI, it decodes the PDSCH carrying RAR. The calculation of RA-RNTI candidate is known by both the UE and gNB. A new working item (WI) for further new radio (NR) coverage enhancement (CovEnh) has been approved in Release (Rel.) 18, where one of the main objectives is to specify the following PRACH coverage enhancements (RAN1, RAN2) [RP-221858]: (1) multiple PRACH transmissions with same beams for 4-step RACH procedure; (2) study, and if justified, specify PRACH transmissions with different beams for 4-step RACH procedure. The enhancements to PRACH are targeted for frequency range 2 (FR2), and can also apply to frequency range 1 (FR1) when applicable. Further, these enhancements to PRACH are targeting short PRACH formats, and can also apply to other formats when applicable. it is still not specified how RA-RNTI is calculated for multi-PRACH transmissions, which is important for decoding the corresponding RAR of multi-PRACH transmissions successfully.

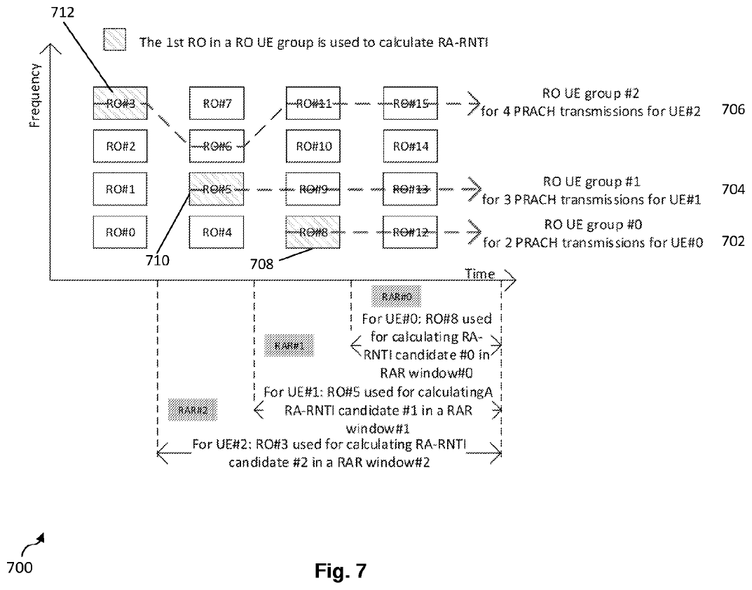

In the present disclosure, one or more RA-RNTI candidates may be calculated in a RO UE group for a specific N number of PRACH transmissions, where N is equal to or greater than 1, based on one of the following solutions: (Solution 1) a single RA-RNTI candidate is calculated based on a plurality of indexes of a resource of a first, n-th, or last RO in the RO UE group (e.g., s_id, t_id, f_id of a first, n-th, or last RO in the RO UE group are used in equation for calculating the single RA-RNTI candidate), where 1<n<N; (Solution 2) the RO UE group may be divided into 2 sub-groups, where a 1st RA-RNTI candidate is calculated based on a plurality of indexes of a resource of a first RO that is included in the 1st sub-group, and a 2^{nd} RA-RNTI is calculated based on a plurality of indexes of a resource of a n-th or last RO that is included in the 2^{nd} sub-group; and (Solution 3) each of one or more RA-RNTI candidates is calculated based on a plurality of indexes of a resource of each of N numbers of ROs that are included in the RO UE group. For example, referring to illustration 700 of FIG. 7, RA-RNTI calculation in each of RO UE groups 702, 704 and 706 are based on Solution 1 in which the plurality of indexes of the resource of the 1^{st} RO in each RO UE group is used for calculating a RA-RNTI candidate for each UE e.g., a RA-RNTI candidate #0 determined based on RO 708 of RO UE group 702 for UE #0, a RA-RNTI candidate #1 determined based on RO 710 of RO UE group 704 for UE #1, and a RA-RNTI candidate #2 determined based on RO 712 of RO UE group 706 for UE #2. In an implementation, the 1^{st} RA-RNTI candidate may be calculated based on a plurality of indexes of a resource of any RO that is included in the 1^{st} subgroup. Advantageously, these solutions enable a UE to decode the corresponding RAR of multi-PRACH transmissions successfully. It will be appreciated that a RO UE group can be referred as a first RO group comprising a plurality of ROs, each of the plurality of ROs in the RO group being used for a PRACH transmission in the multi-PRACH transmission. A plurality of ROs included in a RO UE group can be same or different from a plurality of ROs included in another RO UE group used by another communication apparatus.

For the RO UE group, it includes N number of ROs for a specific N number of PRACH transmissions which may be sent in, for example, one PRACH attempt. One preamble may be sent in each of the N ROs of the RO UE group. The RO UE group can be associated with one or more Synchronization Signal Block (SSB) indices, or associated with at least two SSB indices when SSB based beam(s) are used to transmit the preamble in each of the N ROs of the RO UE group. Moreover, the RO UE group can also be associated with one or more channel state information reference signal (CSI-RS) indices when CSI-RS based beam(s) are used to transmit the preamble in each of the N ROs of the at least one RO UE group. The SSB based and/or CSI-RS based beam(s) can be configured to the UE by gNB.

In an implementation, the RO UE group includes N ROs for N PRACH transmissions. N PRACH transmissions may be referred as multiple PRACH transmissions, a multi-PRACH transmission, or one PRACH attempt. When a UE is capable of multi-PRACH transmission, the UE can send N PRACH transmissions based on N ROs in the RO UE group in one PRACH attempt, where the one PRACH attempt may be referred to a process of sending the N PRACH transmissions. Further, the first, n-th or last RO in the RO UE group can be defined based on the following order: first, in increasing order of frequency resource indexes for frequency multiplexed PRACH occasions; second, in increasing order of time resource indexes for time multiplexed PRACH occasions within a logical/physical PRACH slot; and third, in increasing order of indexes for logical/physical PRACH slots. There can be other possibilities to define the sequence ordering of ROs in the RO UE group (e.g., first, in increasing order of time resource indexes for time multiplexed PRACH occasions within a logical/physical PRACH slot; second, in increasing order of indexes for logical/physical PRACH slots; and third, in increasing order of frequency resource indexes for frequency multiplexed PRACH occasions), the solutions are applicable to any of these other possibilities. In addition, the solutions are also applicable to all UE capabilities, e.g., reduced capacity (RedCap) UE, non-RedCap UE/legacy UE, and other similar types.

Since the UE sends preamble based on N ROs in the RO UE group in a multi-PRACH transmission to a gNB, the gNB sends a RAR to the UE as a response, which is referred to as a message 2 (Msg2). The UE monitors to receive the RAR within a RAR window, e.g., a receiving window. The RAR includes timing advance command, uplink grant, and TC-RNTI for subsequent uplink data transmission (e.g., message 3 (Msg3)). To do so, the UE needs to receive and decode a downlink control information (DCI) with CRC scrambled by a RA-RNTI in order to decode PDSCH, which is scheduled by the DCI, that carries the RAR. The calculation of the RA-RNTI is known by both UE and gNB.

In Solution 1, UE may calculate a single RA-RNTI candidate based on one of N ROs in the RO UE group, based on one of following options, and receives the DCI with CRC scrambled by the single RA-RNTI in a RAR window. In an Option 1, a plurality of indexes of a resource (e.g., s_id, t_id, f_id) of a first RO in the RO UE group are used in equation for calculating the single RA-RNTI candidate (e.g., RA-RNTI=1+s_id+14×t_id+14×80×f_id+14×80×8×ul_carrier_id). The RAR window may start from at least one OFDM symbol after a last OFDM symbol of the first RO, and end at at least one OFDM symbol after a last OFDM symbol of a last RO in the RO UE group. For example, the RAR window may start from an OFDM symbol determined based on a first RO of the RO UE group, and may end at an OFDM symbol determined based on a determined length and a last RO of the RO UE group, and a single RA-RNTI candidate to be used in the RAR window may be determined based on the first RO of the RO group. The determined length may be indicated by a higher layer signalling, MAC signalling, or the downlink control information.

In an Option 2, a plurality of indexes of a resource (e.g., s_id, t_id, f_id) of a n-th RO in the RO UE group are used in equation for calculating the single RA-RNTI candidate. The RAR window may start from at least one OFDM symbol after a last OFDM symbol of the n-th RO, and end at at least one OFDM symbol after the last OFDM symbol of the last RO in the RO UE group. For example, the RAR window may start from an OFDM symbol determined based on n-th RO of the RO UE group, and may end at an OFDM symbol determined based on a determined length and a last RO of the RO UE group, and a single RA-RNTI candidate to be used in the RAR window may be determined based on the n-th RO of the RO group. The determined length may be indicated by a higher layer signalling, MAC CE signalling, or the downlink control information.

In an Option 3, a plurality of indexes of a resource (e.g., s_id, t_id, f_id) of a last RO in the RO UE group are used in equation for calculating the single RA-RNTI candidate. The RAR window may start from least one OFDM symbol after the last OFDM symbol of the last RO, and end at at least one OFDM symbol after the last OFDM symbol of the last RO in the RO UE group. For example, the RAR window may start from an OFDM symbol determined based on last RO of the RO UE group, and may end at an OFDM symbol determined based on a determined length and a last RO of the RO UE group, and a single RA-RNTI candidate to be used in the RAR window may be determined based on the last RO of the RO group. The determined length may be indicated by a higher layer signalling, MAC CE signalling, or the downlink control information.

In Option 1 or Option 2 or Option 3, for receiving the RAR of a multi-PRACH transmission, a UE may receive and decode a DCI with a CRC scrambled by the single RA-RNTI candidate to decode the PDSCH carrying the RAR.

For Option 1, early termination of multi-PRACH transmissions is advantageously possible to save UE effort, e.g., to terminate the next PRACH transmission(s) in advance if the UE successfully receives the RAR. For Option 3, the legacy length of RAR window can advantageously be reused to minimize specifications impact.

For Solution 1, a UE may be configured to determine one of the 3 Options to calculate the RA-RNTI candidate by implicit indication via a rule (e.g., If N=1, Option 1 is used. If 1<N<a threshold value, Option 2 is used. Otherwise, Option 3 is used. For instance, the threshold value can be configured or predefined as 3. If N=2, Option 2 is used. If N=3, Option 3 is used) or explicit indication by a higher layer signalling, MAC CE signalling, or the downlink control information.

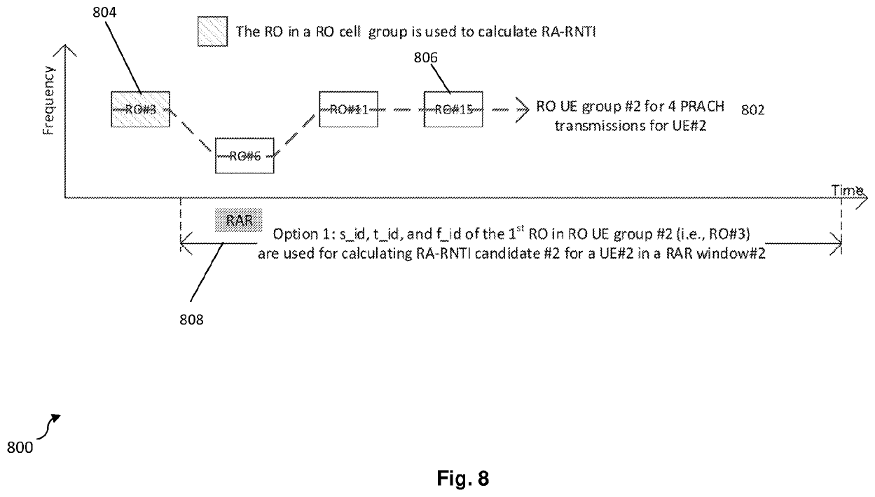

FIG. 8 shows an example illustration 800 of a RA-RNTI candidate calculation for a RO UE group 802 based on Option 1, in which the RA-RNTI candidate is calculated based on a plurality of indexes of a resource (e.g., s_id, t_id, f_id) of first RO (e.g., RO 804) of the RO UE group 802. RAR window 808 starts from at least one OFDM symbol after a last OFDM symbol of the RO 804, and end at at least one OFDM symbol after a last OFDM symbol of last RO 806 in the RO UE group 802.

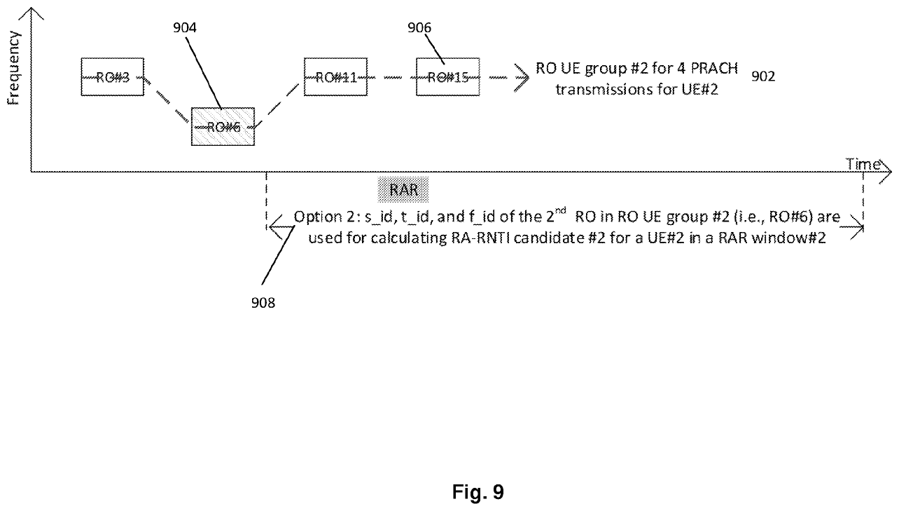

FIG. 9 shows an example illustration 900 of a RA-RNTI candidate calculation for a RO UE group 902 based on Option 2, in which the RA-RNTI candidate is calculated based on a plurality of indexes of a resource (e.g., s_id, t_id, f_id) of a n-th RO (e.g., RO 904) of the RO UE group 902. RAR window 908 may start from at least one OFDM symbol after a last OFDM symbol of the RO 904, and end at at least one OFDM symbol after the last OFDM symbol of last RO 906 in the RO UE group 902.

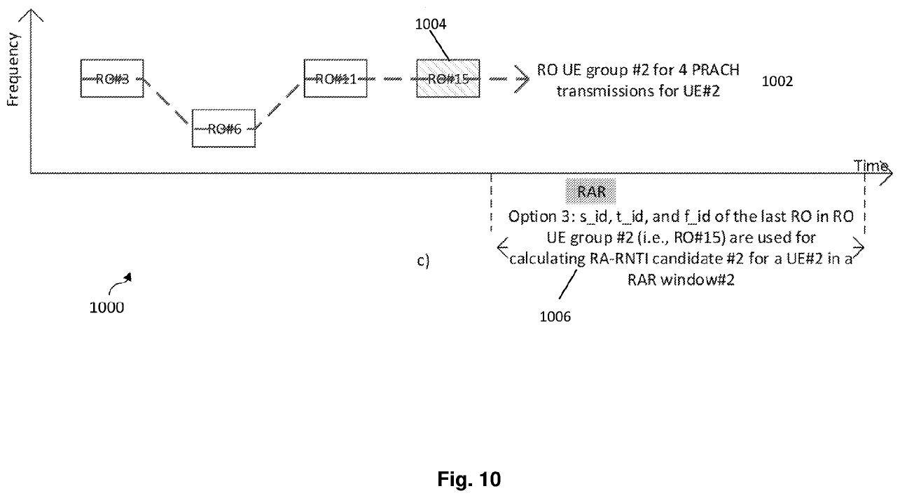

FIG. 10 shows an example illustration 1000 of a RA-RNTI candidate calculation for a RO UE group 1002 based on Option 3, in which the RA-RNTI candidate is calculated based on a plurality of indexes of a resource (e.g., s_id, t_id, f_id) of a last RO (e.g., RO 1004) of the RO UE group 1002. RAR window 1006 may start from at least one OFDM symbol after a last OFDM symbol of the RO 1004, and end at at least one OFDM symbol after the last OFDM symbol of RO 1004 in the RO UE group 1002.

In Solution 2, a RO UE group may be divided into 2 sub-groups, where a 1^{st} sub-group (e.g., comprising N ROs) includes at least a 1^{st} RO in the RO UE group and a 2^{nd} sub-group includes the remaining ROS (1<n≤N) in the RO UE group. A short RAR window may be configured for the 1st sub-group, where it may start from at least one OFDM symbol after a last OFDM symbol of a first PRACH transmission, and end at at least one OFDM symbol after or before a last OFDM symbol of a n-th RO. Further, a long RAR window may be configured for the 2^{nd} sub-group to start from at least one OFDM symbol after the last OFDM symbol of the n-th RO in the RO UE group, and end at at least one OFDM symbol after a last OFDM symbol of a last RO in the RO UE group. In an implementation, a long RAR window may be configured for the 1^{st} subgroup and a short RAR window may be configured for the 2^{nd} subgroup. Further, the RO UE group may also be divided into at least 2 sub-groups, such that a first subgroup comprises at least a first RO in the RO UE group, and a second or more subgroups comprise the remaining ROs in the RO UE group, and a corresponding RAR window for each of the at least 2 subgroups are configured accordingly. Further, instead of a long RAR window and a short RAR window, it can be possible that a same length of the RAR window is configured for the 1^{st} subgroup and the 2^{nd} subgroup. Further, it is also possible to divide a RO UE group into 3 or more than 3 sub-groups.

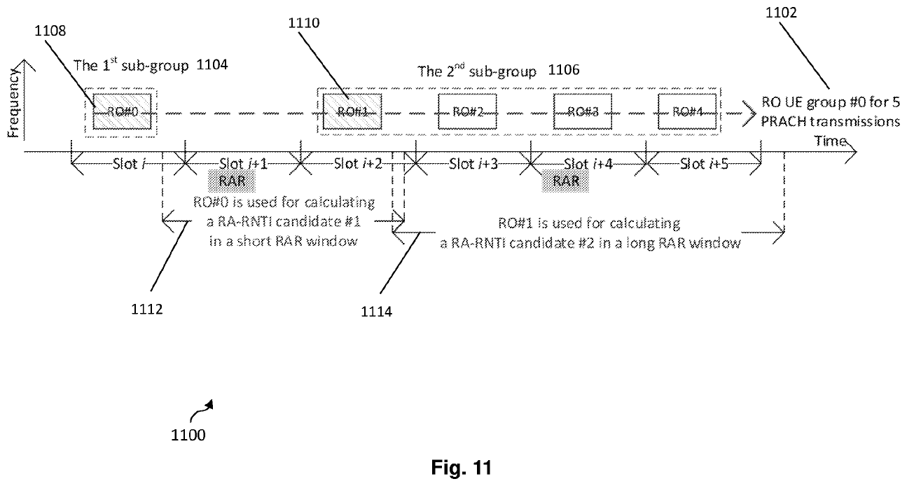

For example, referring to illustration 1100 of FIG. 11, the 1st RA-RNTI candidate may be calculated based on a plurality of indexes of a resource of the 1st RO (e.g., RO 1108) for the 1st sub-group (e.g., sub-group 1104) of the RO UE group (e.g., RO UE group 1102) within the short RAR window (e.g., RAR window 1112), while the 2nd RA-RNTI candidate is calculated based on a plurality of indexes of a resource of a n-th or last RO for the 2nd sub-group (e.g., sub-group 1106) within the long RAR window (e.g., RAR window 1114). In illustration 1100, assuming n=2 is configured, the 2nd RA-RNTI candidate is calculated based on a plurality of indexes of a resource of the 2^{nd} RO of RO UE group 1102 (e.g., RO 1110). For receiving RAR of the multi-PRACH transmission within the short RAR window 1112, UE receives a DCI with CRC scrambled by the 1st RA-RNTI candidate to decode the PDSCH carrying RAR. For receiving RAR of the multi-PRACH transmission within the long RAR window 1114, UE receives a DCI with CRC scrambled by the 2^{nd} RA-RNTI candidate to decode the PDSCH carrying RAR. If a density of ROs of multi-PRACH transmissions is different in time-domain, it is beneficial to provide a flexible configuration of RAR windows such that early termination of multi-PRACH transmissions is possible to save UE effort if UE successfully receives the RAR.

In an implementation, there can be one or more short RAR windows, and one or more long RAR windows. These RAR windows can overlap each other in time-domain depending on the configuration. Accordingly, a RA-RNTI candidate is calculated for each of the one or more short RAR windows and each of the one or more long RAR windows. In a case that the RAR windows are overlapped with each other in time-domain, only one of a RA-RNTI candidate relating to one of two RAR windows may be available for the overlapped part of RAR windows. For example, only a RA-RNTI candidate relating to the short RAR window may be available and a RA-RNTI candidate relating to the long RAR window may not be available for the overlapped part of RAR windows.

In Solution 3, each of N RA-RNTI candidates is calculated based on a plurality of indexes of a resource of each of N ROs in a RO UE group. The N RA-RNTI candidates are related to the corresponding N RAR windows, respectively. Each of N RAR windows may start from at least one OFDM symbol after a last OFDM symbol of a corresponding PRACH transmission in a multi-PRACH transmission and end at at least one OFDM symbol after or before a last OFDM symbol of a next PRACH transmission (e.g., the PRACH transmission after the corresponding PRACH transmission) in the multi-PRACH transmission. The N RAR windows can overlap each other in time-domain depending on the configuration. For receiving RAR(s) of multi-PRACH transmissions, within each of N RAR windows, a UE receives a DCI with CRC scrambled by the corresponding RA-RNTI candidate and attempts to detect the DCI to decode the PDSCH carrying RAR.

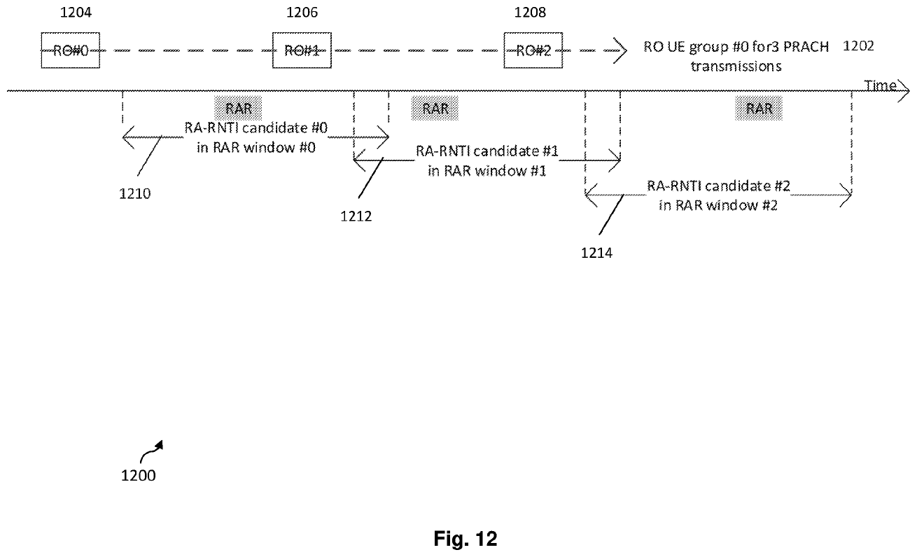

For example, referring to illustration 1200 of FIG. 12 in which N=3, 3 RA-RNTI candidates (e.g., RA-RNTI candidates #0, #1 and #2) are calculated based on a plurality of indexes of a resource of each of 3 ROs (e.g., ROs 1204, 1206 and 1208 each corresponding to a PRACH transmission) in RO UE group 1202. Accordingly, the 3 RA-RNTI candidates are each related to a corresponding RAR window (e.g., RA-RNTI candidates #0, #1 and #2 are related to RAR windows 1210, 1212 and 1214 respectively).

There can be multiple RARs for N PRACH transmissions. In an implementation, less UE effort might be required if the N RAR windows are not overlapping each other in time-domain, or a duration of applicability of a RA-RNTI candidate is limited from a start of its related RAR window until a start of its subsequence RAR window in a case that the N RAR windows are overlapping each other. For example, in FIG. 12, the UE may decode the RAR by using only RA-RNTI candidate #0 until a start of RAR window 1212, and the UE may decode the RAR by using only RA-RNTI candidate #1 from a start of RAR window 1212 until a start of RAR window 1214, and so on. As an alternative way, the UE may decode the RAR by using only RA-RNTI candidate #0 until an end of RAR window 1210, and the UE may also decode the RAR by using only RA-RNTI candidate #1 after an end of RAR window 1210 until an end of RAR window 1212, and by using only RA-RNTI candidate #2 after an end of RAR window 1212 until an end of RAR window 1214. Advantageously, early termination of multi-PRACH transmissions is possible in Solution 3 to save UE effort.

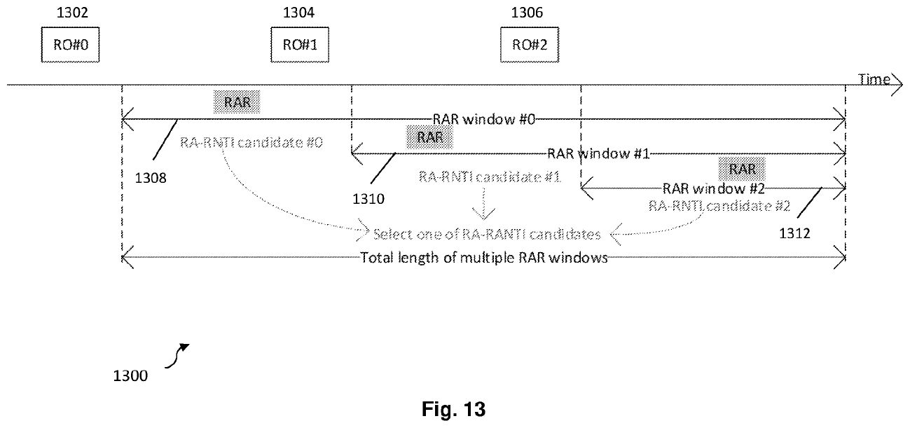

In a variation of Solution 3 (e.g., Solution 3.1), N RA-RNTI candidates may be calculated based on ROs of multi-PRACH transmission in multiple RAR windows, respectively. Each of N RAR windows can start from at least one OFDM symbol after a last OFDM symbol of a corresponding multi-PRACH transmission and end at at least one OFDM symbol after a last OFDM symbol of a last RO. For example, referring to illustration 1300 of FIG. 13 in which N=3, RA-RNTI candidates #0, #1 and #2 are related to RAR windows 1308, 1310 and 1312 respectively. RAR window 1308 starts from at least one OFDM symbol after a last OFDM symbol of RO 1302 and ends at at least one OFDM symbol after a last OFDM symbol of last RO 1306. RAR window 1310 starts from at least one OFDM symbol after a last OFDM symbol of RO 1304 and ends at at least one OFDM symbol after the last OFDM symbol of last RO 1306. Further, RAR window 1312 starts from at least one OFDM symbol after a last OFDM symbol of RO 1306 and ends at at least one OFDM symbol after the last OFDM symbol of RO 1306.

For receiving RAR(s) of multi-PRACH transmission, within a total length of N RAR windows, UE receives a DCI with CRC scrambled by only one of N RA-RNTI candidates. Referring to FIG. 13 for example, the UE receives a DCI with CRC scrambled by only one of the RA-RNTI candidates #0, #1 or #2. The UE attempts to detect the DCI to decode the PDSCH carrying RAR. The RA-RNTI candidate can be selected from the N RA-RNTI candidates by gNB based on one of the following options: (Option 3.1a) based on a first RO from the multi-PRACH transmission; (Option 3.1b) based on a last RO from the multi-PRACH transmission; and (Option 3.1c) based on a n-th RO from the multi-PRACH transmission, where the n-th RO is different from the first and the last RO. It will be appreciated that Solution 3.1 implemented with Option 3.1b is similar to Solution 1 implemented with Option 3, in which there can be just one RAR for N PRACH transmissions.

In an alternative implementation, one or more RA-RNTI candidates may be calculated based on each of M numbers of RO cell group(s) for a specific N number of PRACH transmissions, where M is equal to or greater than 1, instead of being calculated based on a RO UE group (e.g., as shown in Solutions 1-3). This alternative implementation may be performed based on one of the following solutions: (Solution 4) a single RA-RNTI candidate for each of the M RO cell group(s) is calculated based on a plurality of indexes of a resource of the first, t-th or last RO from T ROs, where 1<t<T, that are included in each of the M RO cell group(s); (Solution 5) a single RA-RNTI candidate for each of the M RO cell group(s) is calculated based on an index of each of the M RO cell group(s) in time-domain; (Solution 6) each of the M RO cell group(s) can be divided into 2 sub-groups, in which a 1st RA-RNTI candidate is calculated based on an index of a 1st sub-group, and a 2nd RA-RNTI is calculated based on an index of a 2nd sub-group in time-domain. Advantageously, this implementation enables corresponding RAR of multi-PRACH transmissions to be successfully decoded. It will be appreciated that a RO cell group can be referred as a second RO group comprising a plurality of ROs and being associated with at least one PRACH transmission in a multi-PRACH transmission from a UE, such that at least one of the plurality of ROs in the second RO group correspond to the at least one PRACH transmission in the multi-PRACH transmission. A RO cell group may comprise one or more ROs that are for use among one or more communication apparatuses. The RO cell group is a kind of cell-specific group in a serving cell, while the RO UE group is a kind of UE-specific group in the serving cell.

For determining RO cell group, when M=1, one RO cell group can be determined by including all possible ROs that can be used for the multiple PRACH transmissions. When M>1, each of the M RO cell groups can be commonly determined in a serving cell based on one of the following methods 1-5: (method 1) by clustering one or more ROs located closely in time-domain; (method 2) by clustering one or more ROs located in a same unit of time, including a same slot/sub-frame/frame, or a same periodicity of configuration for a specific number of multiple PRACH transmissions; (method 3) by clustering one or more ROS located closely in frequency-domain; (method 4) by clustering one or more ROS located at a same frequency resource allocation; and (method 5) by clustering one or more ROs located closely in frequency and time domains. The one or more ROS can be separate or shared ROs that are separated from or shared with single PRACH transmission respectively. Each of the one or more ROs in the above-mentioned methods 1-5 may have certain time and frequency resource allocations. The M RO cell group(s) may be determined based on a cell-specific (pre-)configuration. At the gNB side, a gNB may be configured to receive the N PRACH transmissions to perform a combining detection of preamble.

In the alternative implementation, the M RO cell group(s) are defined commonly between UEs in a serving cell. The first, t-th or last in a RO cell group may be defined based on the following order: first, in increasing order of frequency resource indexes for frequency multiplexed PRACH occasions; second, in increasing order of time resource indexes for time multiplexed PRACH occasions within a logical or physical PRACH slot; and third, in increasing order of indexes for logical or physical PRACH slots.

In Solution 4, a single RA-RNTI candidate is calculated for each of M RO cell group(s), in which the RA-RNTI candidate is related to a RAR window. The Options 1, 2, and 3 of Solution 1 as described above can be adapted to calculate the single RA-RNTI candidate based on one or more RO cell groups (instead of being based on one or more RO UE groups as required in solutions 1, 2 and 3) and define corresponding related RAR window(s). There can be M RA-RNTI candidates for M RO cell group(s). The UE may be configured to select one of the M RA-RNTI candidates based on one of the following options: in an Option 4a, the selection is based on an association of a first RO in a RO UE group with its corresponding RO cell group; in an Option 4b, the selection is based on an association of a n-th RO in the RO UE group with its corresponding RO cell group; and in an Option 4c, the selection is based on an association of a last RO (from N ROs) in the RO UE group with its corresponding RO cell group.

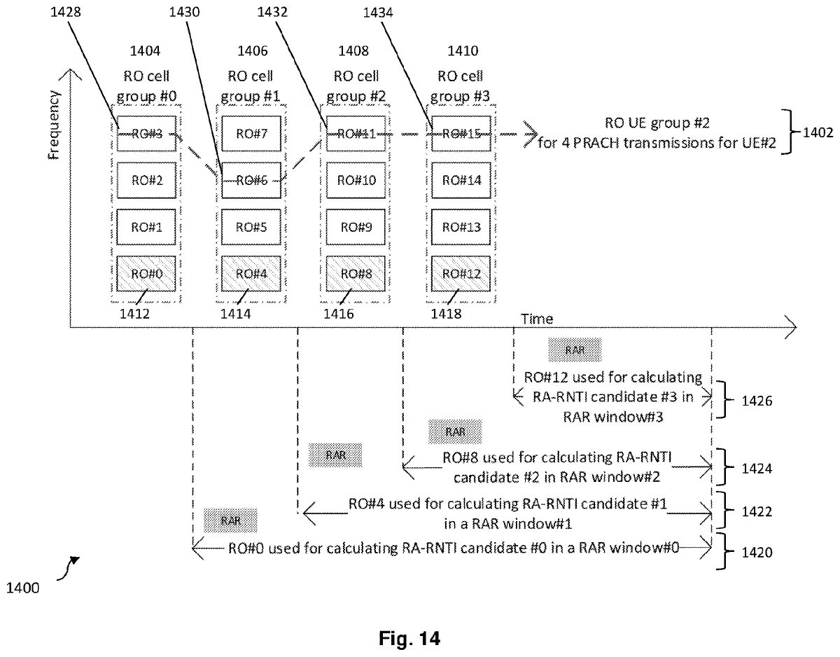

FIG. 14 shows an example illustration 1400 depicting a selection of a RA-RNTI candidate (e.g., from 4 RA-RNTI candidates #0, #1, #2 and #3) based on Options 4a, 4b and 4c for a UE (e.g., RO UE group 1402 for 4 PRACH transmissions for the UE) according to Solution 4, wherein a first RO in each RO cell group is used to calculate a corresponding RA-RNTI candidate. Based on Option 4a, the UE selects a first RO (e.g., RO 1412) of RO cell group 1404 (since RO cell group 1404 is associated with a first RO (e.g., RO 1428) of RO UE group 1402) as the RA-RNTI candidate #0. Based on Option 4b (in which the n-th RO is a second RO), the UE selects a first RO (e.g., RO 1414) of RO cell group 1406 (since RO cell group 1406 is associated with the second RO (e.g., RO 1430) of RO UE group 1402) as the RA-RNTI candidate #1. Also based on Option 4b (in which the n-th RO is a third RO), the UE selects a first RO (e.g., RO 1416) of RO cell group 1408 (since RO cell group 1408 is associated with the third RO (e.g., RO 1432) of RO UE group 1402) as the RA-RNTI candidate #2. Further based on Option 4c, the UE selects a first RO (e.g., RO 1418) of RO cell group 1410 (since RO cell group 1410 is associated with a last RO (e.g., RO 1434) of RO UE group 1402) as the RA-RNTI candidate #3. For receiving RAR of the multi-PRACH transmission, the UE then receives a DCI with CRC scrambled by a single selected RA-RNTI candidate to decode the PDSCH carrying RAR. Since the M RO cell group(s) are a cell-specific configuration, the M RA-RNTI candidates can also be cell-specific candidates such that it advantageously minimizes effort of a gNB for calculating all possible RA-RNTI candidates.

In Solution 5, a single RA-RNTI candidate for each of the M RO cell group(s) is calculated based on an index (e.g., an index in equation RA-RNTI=1+s_id+14×t_id+14×80×f_id+14×80×8×ul_carrier_id for calculating the single RA-RNTI candidate) of each of the M RO cell group(s). Indexes s_id and t_id can be derived based on the index of each of the M RO cell group(s) in time-domain, while index f_id can be derived based on one of the following options in frequency-domain: in an Option 5a, index f_id can be derived based on the index of frequency hopping in the each of the M RO cell group(s); and in an Option 5b, index f_id can be derived based on the index of frequency resource of a first, t-th or last RO in each of the M RO cell group(s). The UE may be configured to select one of M RA-RNTI candidates based on Options 4a, 4b and 4c of Solution 4. The Options 1, 2, and 3 of Solution 1 as described above can be adapted to calculate the RA-RNTI candidate(s) and define corresponding related RAR window(s) based on the M RO cell group(s) (instead of being based on one or more RO UE groups as required in solutions 1, 2 and 3). For receiving RAR of the multi-PRACH transmission, the UE then receives a DCI with CRC scrambled by a single selected RA-RNTI candidate to decode the PDSCH carrying RAR. Since the M RO cell group(s) are a cell-specific configuration, the M RA-RNTI candidates can also be cell-specific candidates such that it advantageously minimizes effort of a gNB for calculating all possible RA-RNTI candidates. The index of a RO cell group in time-domain can be implicitly indicated based on a rule from its own included ROs or explicitly indicated from gNB.

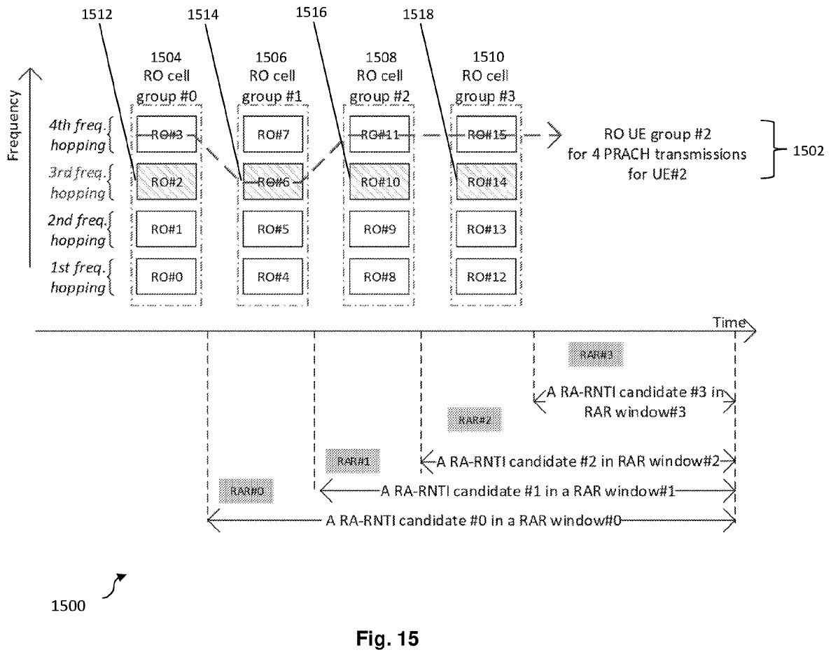

FIG. 15 shows an example illustration 1500 of selecting RA-RNTI candidates for a UE (e.g., RO UE group 1502 for 4 PRACH transmissions for the UE) based on a Solution 5 and an Option 5a according to various embodiments of the present disclosure. For example, s_id and t_id are derived based on the index of each RO cell group (e.g., each of RO cell groups 1504, 1506, 1508 and 1510) in time-domain, and f_id is derived based on a 3rd index of frequency hopping for each RO cell group (e.g., based on ROs 1512, 1514, 1516 and 1518 in RO cell groups 1504, 1506, 1508 and 1510 respectively) in frequency-domain.

In Solution 6, each of M RO cell group(s) may be divided into 2 sub-groups e.g., a 1st and a 2nd sub-group. A 1st RA-RNTI candidate is calculated based on an index of the 1st sub-group, e.g., in equation for calculating the 1st RA-RNTI candidate. Indexes s_id and t_id can be derived based on the index of the 1st sub-group in time-domain, while index f_id can be derived based on one of the following options: in an Option 6a, index f_id can be derived based on an index of frequency hopping in the 1st sub-group, while in an Option 6b, index f_id can be derived based on an index of frequency resource of a first, t-th or last RO in the 1st sub-group. A 2nd RA-RNTI candidate is calculated based on an index of the 2nd sub-group, i.e., in equation for calculating the 2nd RA-RNTI candidate. Indexes s_id and t_id can be derived based on the index of the 2nd sub-group in time-domain, while f_id can be derived based on either Option 6a or Option 6b for the 2nd sub-group.

The UE may be configured to select 2 RA-RNTI candidates from 2M RA-RNTI candidates (since there are M RO cell group(s)) for the 2 sub-groups based on Option 4a, 4b or 4c of Solution 4. The Options 1, 2, and 3 of Solution 1 as described above can be adapted to define corresponding related RAR window(s) based on the M RO cell group(s) (instead of being based on one or more RO UE groups as required in solutions 1, 2 and 3). For receiving RAR of the multi-PRACH transmission, the UE then receives a DCI with CRC scrambled by a single selected RA-RNTI candidate to decode the PDSCH carrying RAR. If a RO cell group is defined by clustering one or more ROs located at a same frequency resource allocation, and a density of ROs in the RO cell group is different in time-domain, this solution allows early termination of multi-PRACH transmissions which advantageously makes it possible to save UE effort if UE successfully receives the RAR. It will be appreciated that, in Solution 6, it is also possible to divide each of the M RO cell group(s) into 2 or more sub-groups, and calculation of each RA-RNTI candidate is accordingly based on indexes of each corresponding sub-group.

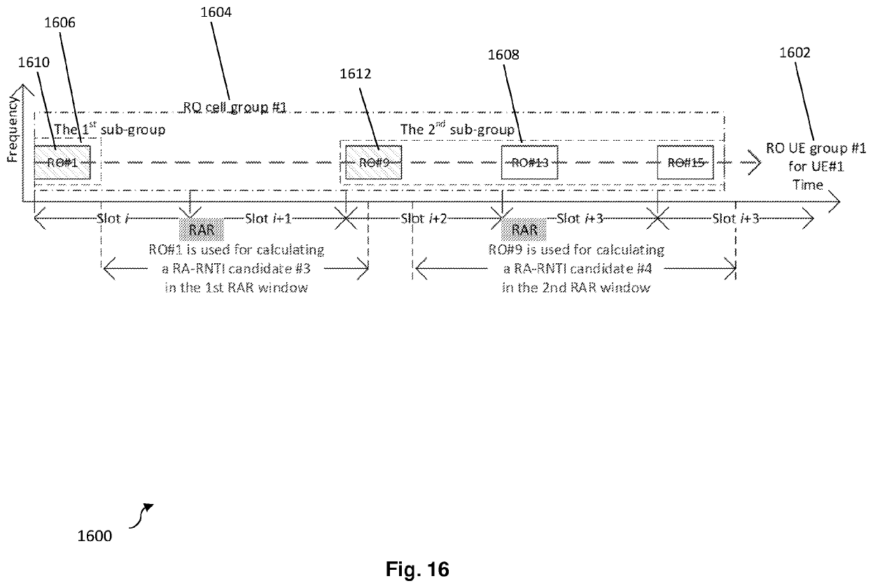

FIG. 16 shows an example illustration 1600 for determining 2 RA-RNTI candidates for a UE (e.g., RO UE group 1602 for the UE) according to Solution 6, in which RO cell group 1604 is divided into 2 sub-groups 1606 and 1608. A first RA-RNTI candidate is calculated based on a first RO (e.g., RO 1610) of sub-group 1606 and a second RA-RNTI candidate is calculated based on a first RO (e.g., RO 1612) of sub-group 1608.

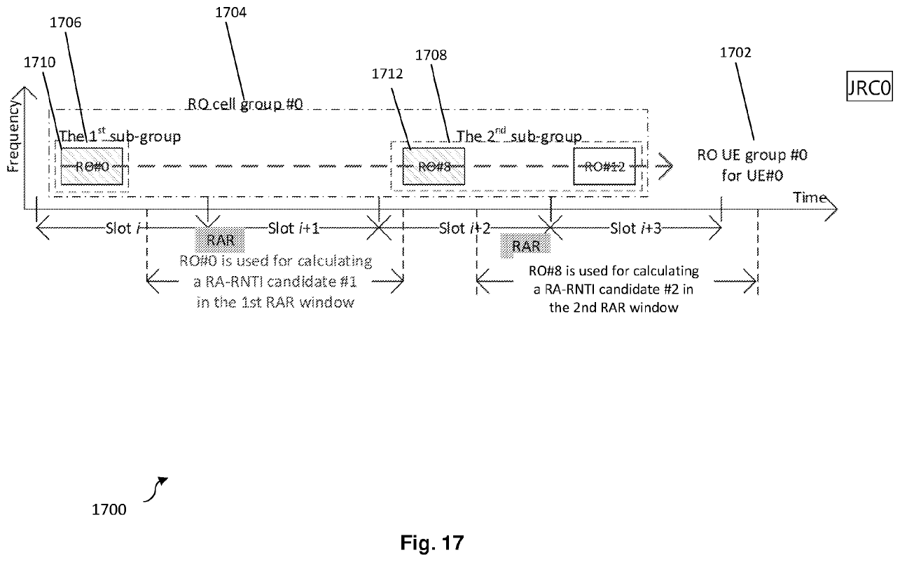

FIG. 17 shows another example illustration 1700 for determining 2 RA-RNTI candidates for a UE (e.g., RO UE group 1702 for the UE) according to Solution 6, in which RO cell group 1704 is divided into 2 sub-groups 1706 and 1708. A first RA-RNTI candidate is calculated based on a first RO (e.g., RO 1710) of sub-group 1706 and a second RA-RNTI candidate is calculated based on a first RO (e.g., RO 1712) of sub-group 1708.

In an implementation, the RAR windows in all the Solutions 1-6 are sliding windows. Further, the length of any RAR window in Solutions 1-6 is configurable such that the length of each of RAR window(s) can be the same or different from one another.

In an implementation, if multi-PRACH transmissions are applied to different coverage levels, wherein there is a subset of PRACH transmissions from the multi-PRACH transmissions for each of the different coverage levels, one or more RA-RNTI candidates per coverage level can be calculated based on Solutions 1-6 and their variations.

In an implementation, the content of the multiple RARs in Solution 2 or Solution 3 can be the same. In Solution 6, the 1st RA-RNTI candidate may be calculated based on a plurality of indexes of a resource of the first RO that is included in the 1st sub-group, and the 2nd RA-RNTI is calculated based on a plurality of indexes of a resource of a t-th or last RO that is included in the 2nd sub-group.

In Solution 1, variations for Option 1, 2 and 3 may be implemented as follows. In Option 1, the RAR window may start from at least one OFDM symbol after the last OFDM symbol of the first RO, and end at a length of L OFDM symbol(s) from the last OFDM symbol of the last RO in the RO UE group (or a length of RAR window), where L is equal to or greater than 1. In Option 2, the RAR window may start at least one OFDM symbol after the last OFDM symbol of the n-th RO, and end at a length of L OFDM symbol(s) from the last OFDM symbol of the last RO in the RO UE group (or a length of RAR window). In Option 3, the RAR window may start at least one OFDM symbol after the last OFDM symbol of the last RO, and end at a length of L OFDM symbol(s) from the last OFDM symbol of the last RO in the RO UE group (or a length of RAR window).

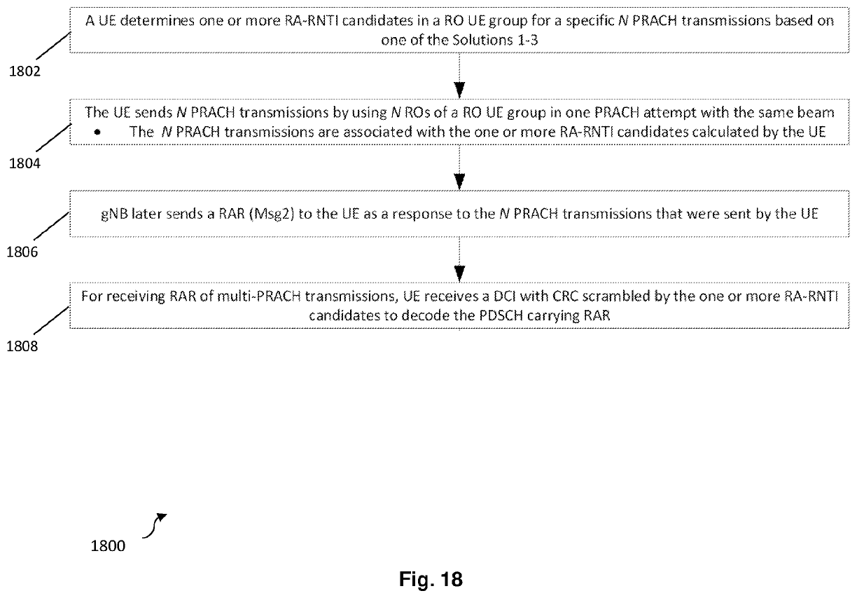

FIG. 18 shows a flow chart 1800 for a UE according to various embodiments of the present disclosure. At step 1802, a UE determines one or more RA-RNTI candidates in a RO UE group for a specific N PRACH transmission based on one of the Solutions 1-3. At step 1804, the UE sends N PRACH transmissions by using N ROs of a RO UE group in one PRACH attempt. N PRACH transmissions may be performed with the same beam. The N PRACH transmission are associated with the one or more RA-RNTI candidates. At step 1806, gNB sends a RAR (e.g., Msg2) to the UE as a response to the N PRACH transmission that were sent by the UE. At step 1808, for receiving RAR of the multi-PRACH transmission, the UE receives a DCI with CRC scrambled by the one or more R-RNTI candidates to decode the PDSCH carrying RAR. The flowchart 1800 can be applicable to a different beam case, where the UE sends N PRACH transmissions by using N ROs of a RO UE group in one PRACH attempt with different beams.

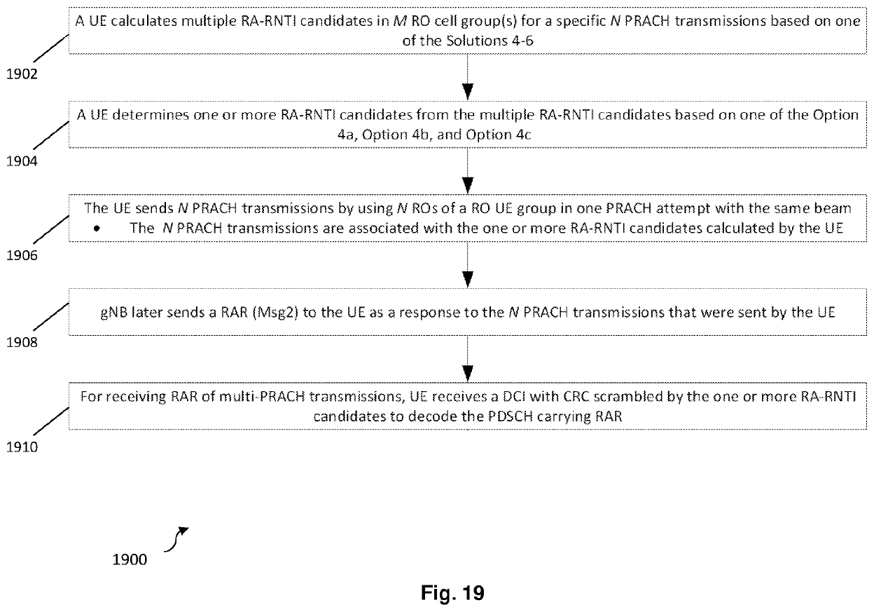

FIG. 19 shows an alternative flow chart 1900 for a UE according to various embodiments of the present disclosure. At step 1902, a UE calculates multiple RA-RNTI candidates in M RO cell group(s) for a specific N PRACH transmissions based one of the Solutions 4-6. At step 1904, the UE determines one or more RA-RNTI candidates from the multiple RA-RNTI candidates based one of the Options 4a, 4b and 4c. At step 1906, the UE sends N PRACH transmissions by using N ROs of a RO UE group in one PRACH attempt with the same beam. The N PRACH transmissions are associated with the one or more RA-RNTI candidates calculated by the UE. At step 1908, a gNB sends a RAR (e.g., Msg2) to the UE in response to the N PRACH transmissions that were sent by the UE. At step 1910, for receiving RAR of the multi-PRACH transmission, the UE receives a DCI with CRC scrambled by the one or more R-RNTI candidates to decode the PDSCH carrying RAR.

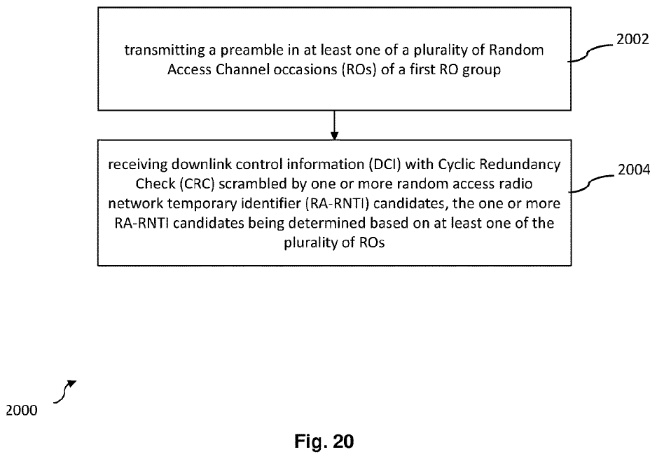

FIG. 20 shows a flow chart illustrating a communication method according to various embodiments of the present disclosure. At step 2002, a preamble may be transmitted in at least one of a plurality of Random Access Channel occasions (ROs) of a first RO group. At step 2004, downlink control information (DCI) with cyclic redundancy check (CRC) scrambled by one or more random access radio network temporary identifier (RA-RNTI) candidates may be received, the one or more RA-RNTI candidates being determined based on at least one of the plurality of ROS.

In an implementation, a preamble may be received in at least one of a plurality of ROs of a first RO group from a communication apparatus; one or more RA-RNTI candidates may be determined based on the at least one of a plurality of ROs of a first RO group, and a DCI with CRC scrambled by the one or more RA-RNTI candidates may be generated; and the DCI may be transmitted to the communication apparatus. In another implementation, a preamble may be received in at least one of a plurality of ROs of a first RO group from a communication apparatus; one or more RA-RNTI candidates may be determined based on an association between at least one of the plurality of ROs in the first RO group and the one or more second RO groups, and a DCI with CRC scrambled by the one or more RA-RNTI candidates may be generated; and the DCI may be transmitted to the communication apparatus.

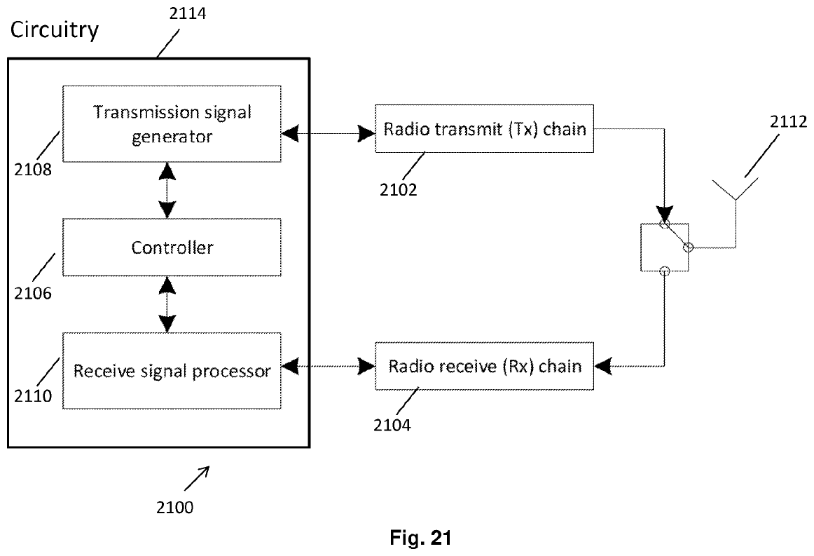

FIG. 21 shows a schematic, partially sectioned view of the communication apparatus 2100 that can be implemented for in accordance with various embodiments and examples as shown in FIGS. 1 to 20. The communication apparatus 2100 may be implemented as a UE or base station according to various embodiments.

Various functions and operations of the communication apparatus 2100 are arranged into layers in accordance with a hierarchical model. In the model, lower layers report to higher layers and receive instructions therefrom in accordance with 3GPP technical specifications. For the sake of simplicity, details of the hierarchical model are not discussed in the present disclosure.

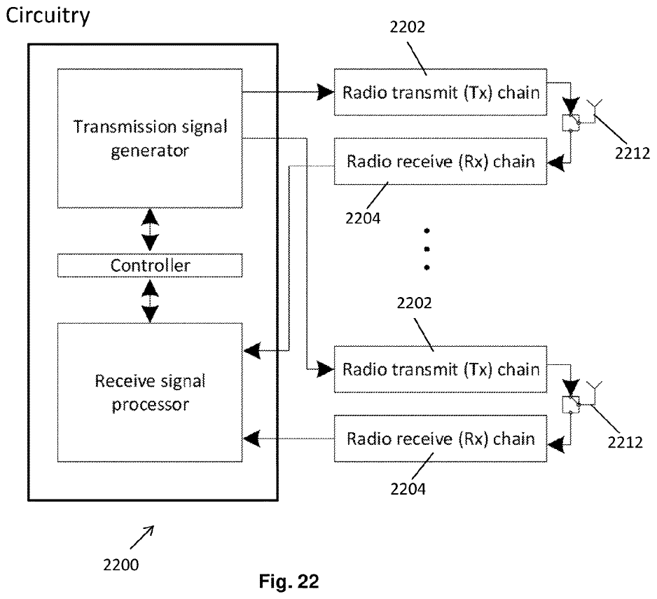

As shown in FIG. 21, the communication apparatus 2100 may include circuitry 2114, at least one radio transmit (Tx) chain 2102 (also referred to herein as transmitter 2102), at least one radio receive (Rx) chain 2104 (also referred to herein as receiver 2104), and at least one antenna 2112 (for the sake of simplicity, only one antenna is depicted in FIG. 21 for illustration purposes). The circuitry 2114 may include at least one controller 2106 for use in software and hardware aided execution of tasks that the at least one controller 2106 is designed to perform, including control of communications with one or more other communication apparatuses in a wireless network. The circuitry 2114 may furthermore include at least one transmission signal generator 2108 and at least one receive signal processor 2110. The at least one controller 2106 may control the at least one transmission signal generator 2108 for generating signals to be sent through the at least one radio transmitter 2102 to one or more other communication apparatuses and the at least one receive signal processor 2110 for processing signals received through the at least one radio receiver 2104 from the one or more other communication apparatuses under the control of the at least one controller 2106. The at least one transmission signal generator 2108 and the at least one receive signal processor 2110 may be stand-alone modules of the communication apparatus 2100 that communicate with the at least one controller 2106 for the above-mentioned functions as shown in FIGS. 1-20. Alternatively, the at least one transmission signal generator 2108 and the at least one receive signal processor 2110 may be included in the at least one controller 2106. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 2102, at least one radio receiver 2104, and at least one antenna 2112 may be controlled by the at least one controller 2106. It will be appreciated that the communication apparatus 2100 may include a plurality of antennas, for example as shown in communication apparatus 2200 of FIG. 22 which includes a plurality of antennas 2212. Each of the plurality of antennas 2212 can include a corresponding Tx chain 2202 and Rx chain 2204.

The communication apparatus 2100, when in operation, provides functions required for RA-RNTI calculation for multi-PRACH transmissions. For example, the communication apparatus 2100 may be a UE, and the transmitter 2102 may, in operation, transmit a preamble in at least one of a plurality of Random Access Channel occasions (ROs) of a first RO group. The receiver 2104 may, in operation, receive downlink control information (DCI) with cyclic redundancy check (CRC) scrambled by one or more random access radio network temporary identifier (RA-RNTI) candidates, the one or more RA-RNTI candidates being determined based on at least one of the plurality of ROs.

The plurality of ROs included in the first RO group may be same or different from a plurality of ROs included in another RO group used by another communication apparatus. A single RA-RNTI candidate may be determined based on a plurality of indexes of a resource of a first, n-th or last RO in the first RO group. The plurality of indexes may comprise an index of a first OFDM symbol of a PRACH occasion, an index of a first slot of the PRACH occasion in a system frame, and an index of the PRACH occasion in frequency domain. The receiver 2102 may be configured to receive the DCI within a random-access response (RAR) window. The RAR window may start from at least one OFDM symbol after a last OFDM symbol of the first RO, n-th RO or last RO respectively, and end at least one OFDM symbol after a last OFDM symbol of the last RO in the first RO group. The RAR window may start from an OFDM symbol determined based on a first RO of the first RO group, and end at an OFDM symbol determined based on a determined length and a last RO of the first RO group, and a single RA-RNTI candidate to be used in the RAR window is determined based on the first RO of the first RO group. The determined length may be indicated by a higher layer signalling, a MAC CE signalling, or the downlink control information.

The circuitry 2114 may, in operation, divide the first RO group into at least two subgroups, a first subgroup comprising at least a first RO in the first RO group and a second or more subgroup comprising the remaining ROs in the first RO group; and determines a first of the one or more RA-RNTI candidates based on a plurality of indexes of a resource of the first RO, and a second of the one or more RA-RNTI candidates based on a plurality of indexes of a resource of an RO in the second subgroup. The circuitry 2114 may be further configured to determine at least one short RAR window for the first subgroup and at least one long RAR window for the second subgroup, the at least one short RAR window being shorter in length than that of the at least one long RAR window. The at least one short RAR window and the at least one long RAR window may be overlapping each other in time-domain.

The circuitry 2114 may be configured to determine each of the one or more RA-RNTI candidates based on each RO of the plurality of ROs in the first RO group. The circuitry 2114 may be configured to determine a RAR window for each RO of the plurality of ROS, the RAR window starting from at least one OFDM symbol after a last OFDM symbol of a PRACH transmission, and ending before or after a last OFDM symbol of a next PRACH transmission. The circuitry 2114 may be configured to determine at least a first RAR window for a first RO of the plurality of ROs and a second RAR window for a second RO of the plurality of ROS, and the first RAR window may start from an OFDM symbol determined based on the first RO and ends at an OFDM symbol determined based on a start of the second RAR window, a length of the first RAR window being shorter than a determined length. Each of the one or more RA-RNTI candidates may relate to its corresponding RAR window.

The circuitry 2114 may, in operation, determine one or more second RO groups, the one or more second RO groups being commonly determined in a serving cell based on clustering one or more ROs located in close proximity to one another in time domain or frequency domain, or in both time and frequency domains; and the plurality of ROs in the first RO group being determined from the one or more second RO groups; and determine the one or more RA-RNTI candidates based on an association between at least one of the plurality of ROs in the first RO group and the one or more second RO groups. The circuitry 2114 may be further configured to determine the one or more RA-RNTI candidates based on a plurality of indexes of a resource of a clustered RO in the one or more second RO groups in addition to the association. The circuitry 2114 may divide each of the one or more second RO groups into at least two subgroups, a first subgroup comprising at least a first RO in the each of the one or more second RO groups and a second or more subgroup comprising the remaining ROs in the each of the one or more second RO groups; and determine a first of the one or more RA-RNTI candidates based on a plurality of indexes of a resource of the first subgroup in addition to the association, and a second of the one or more RA-RNTI candidates based on an a plurality of indexes of a resource of the second subgroup in addition to the association.

The circuitry 2114 may, in operation, determine the one or more RA-RNTI candidates for each of one or more coverage levels. The receiver 2104 may be further configured to receive one or more DCIs with cyclic redundancy check (CRC) scrambled by the one or more RA-RNTI candidates, the communication apparatus further comprising circuitry, which in operation, decodes each DCI to obtain a PDSCH carrying RAR.

The communication apparatus 2100 may be a base station, and the receiver 2104 may, in operation, receive a preamble in at least one of a plurality of ROs of a first RO group from a communication apparatus. The circuitry 2114 may, in operation, determine one or more RA-RNTI candidates based on the at least one of a plurality of ROs of a first RO group, and generates a DCI with CRC scrambled by the one or more RA-RNTI candidates. The transmitter 2104 may, in operation, transmit the DCI to the communication apparatus.

### Control Signals

In the present disclosure, the downlink control signal (information) related to the present disclosure may be a signal (information) transmitted through PDCCH of the physical layer or may be a signal (information) transmitted through a MAC Control Element (CE) of the higher layer or the RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or the RRC. Further, the uplink control signal may be a pre-defined signal (information). The uplink control signal may be replaced with uplink control information (UCI), the first stage sidelink control information (SCI) or the second stage SCI.

### Base Station

In the present disclosure, the base station may be a Transmission Reception Point (TRP), a cluster head, an access point, a Remote Radio Head (RRH), an eNodeB (eNB), a gNodeB (gNB), a Base Station (BS), a Base Transceiver Station (BTS), a base unit or a gateway, for example. Further, in sidelink communication, a terminal may be adopted instead of a base station. The base station may be a relay apparatus that relays communication between a higher node and a terminal. The base station may be a roadside unit as well.

### Uplink/Downlink/Sidelink

The present disclosure may be applied to any of uplink, downlink and sidelink.

The present disclosure may be applied to, for example, uplink channels, such as PUSCH, PUCCH, and PRACH, downlink channels, such as PDSCH, PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

### Data Channels/Control Channels

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

### Reference Signals

In the present disclosure, the reference signals are signals known to both a base station and a mobile station and each reference signal may be referred to as a Reference Signal (RS) or sometimes a pilot signal. The reference signal may be any of a DMRS, a Channel State Information-Reference Signal (CSI-RS), a Tracking Reference Signal (TRS), a Phase Tracking Reference Signal (PTRS), a Cell-specific Reference Signal (CRS), and a Sounding Reference Signal (SRS).

### Time Intervals

In the present disclosure, time resource units are not limited to one or a combination of slots and symbols, and may be time resource units, such as frames, superframes, subframes, slots, time slot subslots, minislots, or time resource units, such as symbols, Orthogonal Frequency Division Multiplexing (OFDM) symbols, Single Carrier-Frequency Division Multiplexing Access (SC-FDMA) symbols, or other time resource units. The number of symbols included in one slot is not limited to any number of symbols exemplified in the embodiment(s) described above, and may be other numbers of symbols.

### Frequency Bands

The present disclosure may be applied to any of a licensed band and an unlicensed band.

### Communication

The present disclosure may be applied to any of communication between a base station and a terminal (Uu-link communication), communication between a terminal and a terminal (Sidelink communication), and Vehicle to Everything (V2X) communication. The channels in the present disclosure may be replaced with PSCCH, PSSCH, Physical Sidelink Feedback Channel (PSFCH), PSBCH, PDCCH, PUCCH, PDSCH, PUSCH, and PBCH.

In addition, the present disclosure may be applied to any of a terrestrial network or a network other than a terrestrial network (NTN: Non-Terrestrial Network) using a satellite or a High Altitude Pseudo Satellite (HAPS). In addition, the present disclosure may be applied to a network having a large cell size, and a terrestrial network with a large delay compared with a symbol length or a slot length, such as an ultra-wideband transmission network.

### Antenna Ports

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

As described above, the embodiments of the present disclosure provide an advanced communication system, communication methods and communication apparatuses that advantageously perform RA-RNTI calculation for multi-PRACH transmissions.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication apparatus.

Some non-limiting examples of such communication apparatus include a phone (e.g., cellular (cell) phone, smart phone), a tablet, a personal computer (PC) (e.g., laptop, desktop, netbook), a camera (e.g., digital still/video camera), a digital player (e.g., digital audio/video player), a wearable device (e.g., wearable camera, smart watch, tracking device), a game console, a digital book reader, a telehealth/telemedicine (e.g., remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

The present disclosure may refer to the following statements:

Statement 1. A communication apparatus, comprising:
a transmitter, which in operation, transmits a preamble in at least one of a plurality of Random Access Channel occasions (ROs) of a first RO group; and
a receiver, which in operation, receives downlink control information (DCI) with cyclic redundancy check (CRC) scrambled by one or more random access radio network temporary identifier (RA-RNTI) candidates, the one or more RA-RNTI candidates being determined based on at least one of the plurality of ROs.

Statement 2. The communication apparatus of Statement 1, wherein the plurality of ROs included in the first RO group are same or different from a plurality of ROs included in another RO group used by another communication apparatus.

Statement 3. The communication apparatus of Statement 1 or 2, wherein a single RA-RNTI candidate is determined based on a plurality of indexes of a resource of a first, n-th or last RO in the first RO group.

Statement 4. The communication apparatus of Statement 3, wherein the plurality of indexes comprises an index of a first OFDM symbol of a PRACH occasion, an index of a first slot of the PRACH occasion in a system frame, and an index of the PRACH occasion in frequency domain.

Statement 5. The communication apparatus of Statements 1 to 3, wherein the receiver is configured to receive the DCI within a random-access response (RAR) window.

Statement 6. The communication apparatus of Statement 5, wherein the RAR window starts from at least one OFDM symbol after a last OFDM symbol of the first RO, n-th RO or last RO respectively, and end at least one OFDM symbol after a last OFDM symbol of the last RO in the first RO group.

Statement 7. The communication apparatus of Statement 5, wherein the RAR window starts from an OFDM symbol determined based on a first RO of the first RO group, and end at an OFDM symbol determined based on a determined length and a last RO of the first RO group, and a single RA-RNTI candidate to be used in the RAR window is determined based on the first RO of the first RO group.

Statement 8. The communication apparatus of Statement 7, wherein the determined length is indicated by a higher layer signalling, a MAC CE signalling, or the downlink control information.

Statement 9. The communication apparatus of Statement 1 or 2, further comprising circuitry, which in operation, divides the first RO group into at least two subgroups, a first subgroup comprising at least a first RO in the first RO group and a second or more subgroup comprising the remaining ROs in the first RO group; and determines a first of the one or more RA-RNTI candidates based on a plurality of indexes of a resource of the first RO, and a second of the one or more RA-RNTI candidates based on a plurality of indexes of a resource of an RO in the second subgroup.

Statement 10. The communication apparatus of Statement 9, wherein the circuitry is further configured to determine at least one short RAR window for the first subgroup and at least one long RAR window for the second subgroup, the at least one short RAR window being shorter in length than that of the at least one long RAR window.

Statement 11. The communication apparatus of Statement 9, wherein the at least one short RAR window and the at least one long RAR window are overlapping each other in time-domain.

Statement 12. The communication apparatus of Statement 1 or 2, further comprising circuitry, which in operation, determines each of the one or more RA-RNTI candidates based on each RO of the plurality of ROs in the first RO group.

Statement 13. The communication apparatus of Statement 12, wherein the circuitry is configured to determine a RAR window for each RO of the plurality of ROs, the RAR window starting from at least one OFDM symbol after a last OFDM symbol of a PRACH transmission, and ending before or after a last OFDM symbol of a next PRACH transmission.

Statement 14. The communication apparatus of Statement 12, wherein the circuitry is configured to determine at least a first RAR window for a first RO of the plurality of ROs and a second RAR window for a second RO of the plurality of ROs, and
the first RAR window starts from an OFDM symbol determined based on the first RO and ends at an OFDM symbol determined based on a start of the second RAR window, a length of the first RAR window being shorter than a determined length.

Statement 15. The communication apparatus of any one of Statements 5, 9 and 12, wherein each of the one or more RA-RNTI candidates relates to its corresponding RAR window.

Statement 16. The communication apparatus of Statement 1 or 2, further comprising circuitry, which in operation, determines one or more second RO groups, the one or more second RO groups being commonly determined in a serving cell based on clustering one or more ROs located in close proximity to one another in time domain or frequency domain, or in both time and frequency domains; and the plurality of ROs in the first RO group being determined from the one or more second RO groups; and determines the one or more RA-RNTI candidates based on an association between at least one of the plurality of ROs in the first RO group and the one or more second RO groups.

Statement 17. The communication apparatus of Statement 16, wherein the circuitry is further configured to determine the one or more RA-RNTI candidates based on a plurality of indexes of a resource of a clustered RO in the one or more second RO group in addition to the association.

Statement 18. The communication apparatus of Statement 16, wherein the circuitry is further configured to:
divide each of the one or more second RO groups into at least two subgroups, a first subgroup comprising at least a first RO in the each of the one or more second RO groups and a second or more subgroup comprising the remaining ROs in the each of the one or more second RO groups; and
determine a first of the one or more RA-RNTI candidates based on a plurality of indexes of a resource of the first subgroup in addition to the association, and a second of the one or more RA-RNTI candidates based on a plurality of indexes of a resource of the second subgroup in addition to the association.

Statement 19. The communication apparatus of Statement 16, wherein the circuitry is further configured to:
divide each of the one or more second RO groups into at least two subgroups, a first subgroup comprising at least a first RO in the each of the one or more second RO groups and a second or more subgroup comprising the remaining ROs in the each of the one or more second RO groups; and
determine a first of the one or more RA-RNTI candidates based on an index of the first subgroup in time domain and an index of frequency hopping of the first subgroup in frequency domain in addition to the association, and a second of the one or more RA-RNTI candidates based on index of the second subgroup in time domain and an index of frequency hopping of the second subgroup in frequency domain in addition to the association.

Statement 20. The communication apparatus of Statement 1, further comprising circuitry, which in operation, determines the one or more RA-RNTI candidates for each of one or more coverage levels.

Statement 21. The communication apparatus of Statement 1, wherein the receiver is further configured to receive one or more DCIs with cyclic redundancy check (CRC) scrambled by the one or more RA-RNTI candidates, the communication apparatus further comprising circuitry, which in operation, decodes each DCI to obtain a PDSCH carrying RAR.

Statement 22. A base station, comprising:
a receiver, which in operation, receives a preamble in at least one of a plurality of ROs of a first RO group from a communication apparatus;
circuitry, which in operation, determines one or more RA-RNTI candidates based on the at least one of a plurality of ROs of a first RO group, and generates a DCI with CRC scrambled by the one or more RA-RNTI candidates; and
a transmitter, which in operation, transmits the DCI to the communication apparatus.

Statement 23. A communication method, comprising:
transmitting a preamble in at least one of a plurality of Random Access Channel occasions (ROs) of a first RO group; and
receiving downlink control information (DCI) with CRC scrambled by one or more random access radio network temporary identifier (RA-RNTI) candidates, the one or more RA-RNTI candidates being determined based on at least one of the plurality of ROs.

Statement 24. A communication method, comprising:
receiving a preamble in at least one of a plurality of ROs of a first RO group from a communication apparatus;
determining one or more RA-RNTI candidates based on the at least one of a plurality of ROs of a first RO group, and generates a DCI with CRC scrambled by the one or more RA-RNTI candidates; and
transmitting the DCI to the communication apparatus.

Statement 25. A communication method, comprising:
receiving a preamble in at least one of a plurality of ROs of a first RO group from a communication apparatus;
determining one or more RA-RNTI candidates based on an association between at least one of the plurality of ROs in the first RO group and the one or more second RO groups, and generates a DCI with CRC scrambled by the one or more RA-RNTI candidates; and
transmitting the DCI to the communication apparatus.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1-20. (canceled)

21. A communication apparatus, comprising:
a transmitter, which, in operation, performs a multiple physical random access channel (PRACH) transmission in a plurality of PRACH occasions (ROs); and
a receiver, which, in operation, receives downlink control information (DCI) by using a random access radio network temporary identifier (RA-RNTI),
wherein the RA-RNTI is determined based on a last RO of the plurality of ROs.

22. The communication apparatus of claim 21, wherein the DCI includes a cyclic redundancy check (CRC) scrambled by the RA-RNTI.

23. The communication apparatus of claim 21, wherein the RA-RNTI is determined based on an index of a first OFDM symbol of the last RO, an index of a first slot of the last RO in a system frame, and an index of the last RO in a frequency domain.

24. The communication apparatus of claims 21, wherein the DCI is received within a random-access response (RAR) window.

25. The communication apparatus of claim 24, wherein the RAR window starts after a last OFDM symbol of the last RO.

26. The communication apparatus of claim 25, wherein the RAR window ends at an OFDM symbol determined based on a length determined by a higher layer signaling and the last RO.

27. The communication apparatus of claim 21, wherein the plurality of ROs is different among a plurality of communication apparatuses.

28. The communication apparatus of claim 21, wherein the plurality of PRACH occasions (ROs) is different in a time domain and is same in a frequency domain.

29. The communication apparatus of claim 21, wherein a number of ROs included in the plurality of ROs is different from a number of ROs included in another plurality of ROs.

30. A communication method, comprising:
performing a multiple physical random access channel (PRACH) transmission in a plurality of PRACH occasions (ROs); and
receiving downlink control information (DCI) by using a random access radio network temporary identifier (RA-RNTI),
wherein the RA-RNTI is determined based on a last RO of the plurality of ROs.

31. The communication method of claim 30, wherein the DCI includes a cyclic redundancy check (CRC) scrambled by the RA-RNTI.

32. The communication method of claim 30, wherein the RA-RNTI is determined based on an index of a first OFDM symbol of the last RO, an index of a first slot of the last RO in a system frame, and an index of the last RO in a frequency domain.

33. The communication method of claims 30, wherein the DCI is received within a random-access response (RAR) window.

34. The communication method of claim 33, wherein the RAR window starts after a last OFDM symbol of the last RO.

35. The communication method of claim 34, wherein the RAR window ends at an OFDM symbol determined based on a length determined by a higher layer signaling and the last RO.

36. The communication method of claim 30, wherein the plurality of ROs is different among a plurality of communication apparatuses.

37. The communication method of claim 30, wherein the plurality of PRACH occasions (ROs) is different in a time domain and is same in a frequency domain.

38. The communication method of claim 30, wherein a number of ROS included in the plurality of ROs is different from a number of ROs included in another plurality of ROs.

39. An integrated circuit, comprising:
transmission circuitry, which, in operation, controls a multiple physical random access channel (PRACH) transmission in a plurality of PRACH occasions (ROs); and
reception circuitry, which, in operation, controls receiving downlink control information (DCI) by using a random access radio network temporary identifier (RA-RNTI),
wherein the RA-RNTI is determined based on a last RO of the plurality of ROs.
